(19) United States
(12) Patent Application Publication
(10) Pub. No.: US 2026/0174059 A1
(43) Pub. Date: Jun. 25, 2026

(54) PET HAIR GROOMING MACHINE

(71) Applicant: YANGZHOU XIAOYI INTELLIGENT TECHNOLOGY CO., LTD, Yangzhou (CN)

(72) Inventors: Yuan Gong, Yangzhou (CN); Kang Zhao, Yangzhou (CN)

(73) Assignee: YANGZHOU XIAOYI INTELLIGENT TECHNOLOGY CO., LTD, Yangzhou (CN)

(21) Appl. No.: 19/542,559

(22) Filed: Feb. 17, 2026

Related U.S. Application Data
(63) Continuation of application No. PCT/CN2024/085586, filed on Apr. 2, 2024.

(30) Foreign Application Priority Data
Aug. 18, 2023 (CN) 2023222422486

(51) Int. Cl. A01K 13/00; A47L 7/00; A47L 9/08; A47L 9/12; A47L 9/14; A47L 9/24; A47L 9/32

(52) U.S. Cl. CPC A01K 13/00; A47L 7/0066; A47L 9/08; A47L 9/12; A47L 9/149; A47L 9/242; A47L 9/32

(57) ABSTRACT

The present disclosure provides a pet hair grooming machine to which a pipeline is connected. The machine comprises a housing, a suction and blowing device disposed inside the housing, and a hair collection chamber arranged outside the housing. A first air inlet and a placement chamber are provided on one side of the housing, and an air nozzle is connected to the pipeline. A clamping member is disposed inside the placement chamber. During grooming, the air nozzle is removed from the positioning slot and connected to the pipeline for use. After grooming, the air nozzle is stored in the clamping member. Such arrangement prevents the air nozzle from being misplaced and avoids pets biting the nozzle as a toy, thereby protecting the nozzle from damage and enabling convenient reuse.

### CROSS REFERENCE TO RELATED APPLICATION

This application is a Continuation of PCT Patent Application No. PCT/CN2024/085586 filed on Apr. 2, 2024, which claims priority of China Patent Application No. 2023222422486 filed on Aug. 18, 2023. The contents of the above-identified applications are incorporated herein by reference.

### TECHNICAL FIELD

The disclosure relates to the technical field of pet supplies, particularly to a pet hair grooming machine.

### BACKGROUND

As living standards improve and life pressure increases, an increasing number of people keep pets (e.g., pet cats) to relieve stress and alleviate loneliness. An important aspect of pet care is grooming their fur, particularly after bathing or trimming. However, pets typically have a large amount of fur, making grooming operations cumbersome. To address this issue, specialized grooming machines have been developed. In the prior art, after using the air nozzle of a pet hair grooming machine for grooming, the machine is not equipped with a placement chamber for accommodating the air nozzle. This often results in the used air nozzle being placed arbitrarily. Additionally, pets are likely to mistake the air nozzle for a toy and play with it, which can cause deformation or damage to the air nozzle and thus affect its subsequent use.

Therefore, there is a room for improvement in the placement of the air nozzle of pet hair grooming machine.

### SUMMARY

The disclosure provides a pet hair grooming machine to solve the problem in the prior art where the air nozzle of a pet hair grooming machine tends to be placed randomly after use, and pets may easily mistake it for a toy, causing deformation or damage, which is inconvenient for subsequent use.

To solve the disadvantage described above, the disclosure provided a pet hair grooming machine including a housing, a pipeline configured to mount to the housing, a suction and blowing device fixed inside the housing and configured to suction hair, a hair collection chamber mounted on an outer surface of the housing and be in communication with the suction and blowing device. Wherein one side of the housing defines a first air inlet in communication with the pipeline and the hair collection chamber; a placement chamber is disposed on the housing and configured to place at least on air nozzle, with one air nozzles is selected to couple to the pipeline away from the housing.

In some embodiments, the placement chamber is disposed on a rear side of the housing, a clamping member disposed within the placement chamber and configured to retain air nozzles at corresponding positions within the placement chamber; the the pet hair grooming further comprises a cover being configured to close or open with relative with the housing so as to cover or uncover the placement chamber.

In some embodiments, a plurality of positioning slots are disposed within the clamping member, the clamping member retains air nozzles by placing the air nozzles in corresponding positioning slots.

In some embodiments, the hair collection chamber and the pipeline are detachably connected to the housing.

In some embodiments, the hair collection chamber defines a second air inlet, and a first air outlet, the second air inlet in communication with the first air inlet, and the first air outlet is in communication with the suction and blowing device.

In some embodiments, a hair blocking plate with a plurality of through holes is disposed within the first air outlet.

In some embodiments, a second air outlet is defined at one end of the housing, the second air outlet is disposed on one side adjacent to the suction and blowing device.

In some embodiments, a first grille plate and a second grille plate are arranged inside the second air outlet, the first grille plate is disposed on an inner side of the second grille plate.

In some embodiments, the first grille plate is integrally formed with the housing.

In some embodiments, a plurality of cushion blocks are arranged on the housing, the cushion blocks are located around the second air outlet.

### Beneficial Effects

Compared with the prior art, the present disclosure provides the following beneficial effects. The pet hair grooming machine of the present disclosure allows the air nozzle to be removed from the positioning slot and connected to the pipeline during pet grooming. After grooming, the air nozzle is placed into the clamping member. This structure effectively prevents the air nozzle from being misplaced and keeps pets from biting the nozzle as a toy, thereby avoiding damage to the air nozzle and facilitating subsequent use.

### BRIEF DESCRIPTION OF THE DRAWINGS

To more clearly illustrate the technical solutions in the embodiments of the disclosure or the prior art, a brief introduction to the drawings used in the embodiments is provided below. The drawings described below are merely corresponding drawings of some embodiments of the disclosure.

FIG. 1 is a perspective view of the pet hair grooming machine in accordance with an embodiment of the disclosure.

FIG. 2 is an exploded view of the pet hair grooming machine in accordance with an embodiment of the disclosure.

FIG. 3 is a perspective view of the housing of the pet hair grooming machine in accordance with an embodiment of the disclosure.

FIG. 4 is a perspective view of the hair collection chamber of the pet hair grooming machine in accordance with an embodiment of the disclosure.

FIG. 5 is a perspective view of the pet hair grooming machine in accordance with an embodiment of the disclosure.

### DETAILED DESCRIPTION OF THE EMBODIMENTS

To make the objectives, technical solutions, and advantages of the embodiments of this disclosure clearer, a clear and complete description of the technical solutions of the embodiments of this disclosure will be provided below in conjunction with the accompanying drawings of the embodiments of this disclosure. Obviously, the described embodiments are part of the embodiments of this disclosure, rather than all of them. All other embodiments obtained by those of ordinary skill in the art based on the described embodiments of this disclosure without creative efforts fall within the scope of protection of this disclosure.

Unless otherwise defined, the technical or scientific terms used herein shall have their usual meanings as understood by those of ordinary skill in the field to which this disclosure pertains.

The terms “first,” “second,” and similar terms used in the specification and claims of this disclosure do not indicate any order, quantity, or importance but are merely used to distinguish different components. Terms such as “comprise” or “include” and similar terms indicate that the elements or objects appearing before “comprise” or “include” encompass the elements or objects listed after “comprise” or “include” and their equivalents, and do not exclude other elements or objects. Terms such as “connect” or “be connected” and similar terms are not limited to physical or mechanical connections but may include electrical connections, whether direct or indirect. Terms such as “upper,” “lower,” “left,” and “right” are only used to indicate relative positional relationships, and when the absolute position of the described object changes, these relative positional relationships may also change accordingly.

Below, a clear and complete description of the technical solutions of the embodiments of the disclosure will be provided in conjunction with the accompanying drawings of the embodiments of the disclosure. Obviously, the described embodiments are merely part of the embodiments of the disclosure, rather than all of them. All other embodiments obtained by those skilled in the art based on the embodiments of the disclosure without creative efforts fall within the scope of protection of the disclosure.

The following is a preferred embodiment of a pet hair grooming machine provided by the disclosure that can solve the above technical problems.

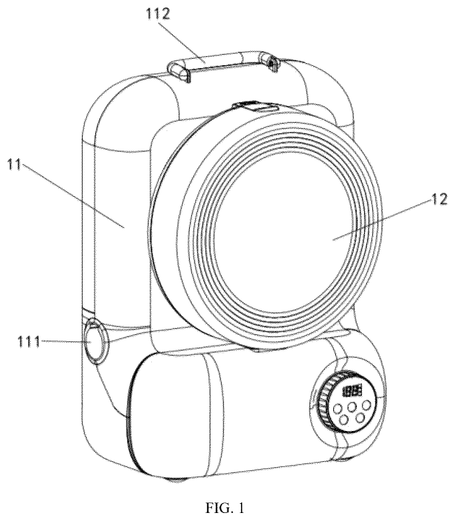

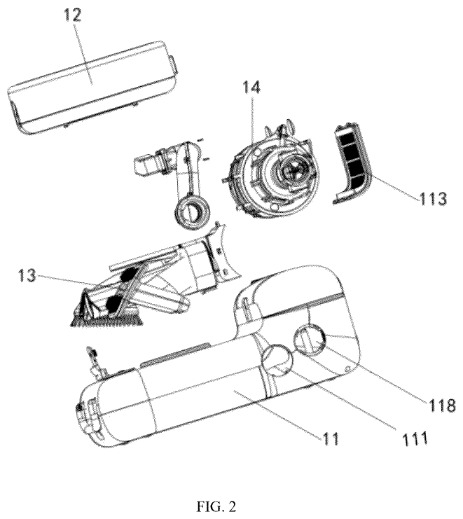

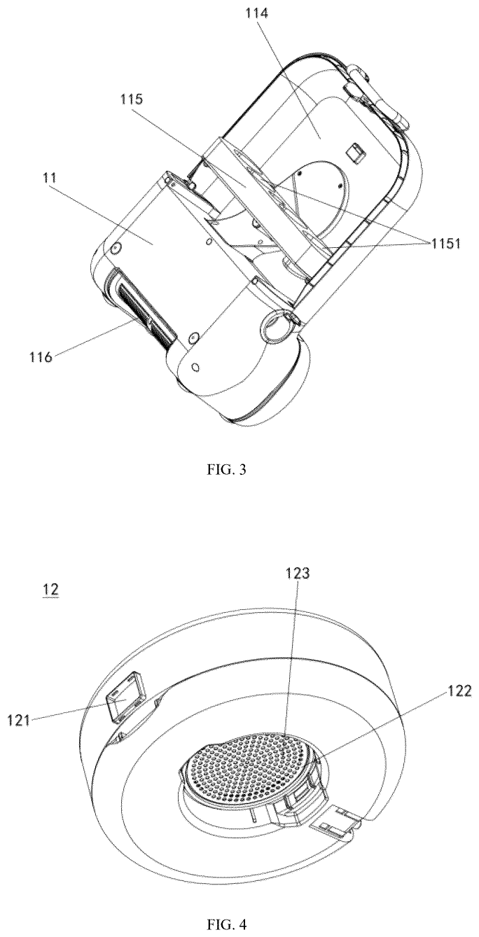

Referring to FIGS. 1, 2, and 3, FIG. 1 is a perspective view of the pet hair grooming machine of the disclosure; FIG. 2 is an exploded view of the pet hair grooming machine of the disclosure; and FIG. 3 is a perspective view of the housing of the pet hair grooming machine of the disclosure.

In the drawings, components of similar structure are designated by the same reference numerals.

The terms “first,” “second,” etc. in the disclosure are used for descriptive purposes only and are not to be construed as indicating or implying relative importance or as a limitation on the order of precedence.

The disclosure provides a pet hair grooming machine with a pipeline (not shown) configured to suck hair. The pet hair grooming machine includes a housing 11, a suction and blowing device 14 fixed inside the housing 11, and a hair collection chamber 12 mounted on an outer surface of the housing 11 and connected to the suction and blowing device 14. One side of the housing 11 defines a first air inlet 111 in communication with the pipeline and the hair collection chamber 12, and a placement chamber 114 disposed within the housing 11 and configured to place air nozzles 13. The air nozzles 13 is configured to be coupled to the pipeline. A clamping member 115 is disposed within the placement chamber 114. The housing 11 is configured to facilitate the installation of the suction and blowing device 14 and the hair collection chamber 12. When the suction and blowing device 14 sucks air, the air enters through the first air inlet 111, passes through the hair collection chamber 12, and is blown out by the suction and blowing device 14, thereby confining the pet's hair within the hair collection chamber 12. The placement chamber 114 is configured to receive at least one air nozzle 13, with one nozzle being selected to couple to the pipeline. The pipeline is arranged to extend the length of the air nozzle 13 connected to the pet hair grooming machine, thereby facilitating the grooming of the pet at various body parts. The clamping member 115 is configured to position and restrict the air nozzle 13, preventing the air nozzle 13 from wobbling inside the placement chamber 114. After use, the air nozzle 13 can be in the placement chamber 114, which effectively prevents it from being placed randomly and keeps pets from playing with it as a toy, thus enabling convenient subsequent use.

In this embodiment, a plurality of air nozzles 13 of different shapes are provided. Correspondingly, a plurality of positioning slots 1151 of different shapes are disposed within the clamping member 115 to position and restrict the air nozzles 13. The positioning slots 1151 are configured to receive the differently shaped air nozzles 13, such that the air nozzles 13 can be conveniently replaced when grooming different parts of the pet, thereby enhancing the convenience of grooming. The suction and blowing device 14 is disposed below the clamping member 115 and outside the placement chamber 114.

In this embodiment, the housing 11 is further provided with a cover plate detachably connected to the placement chamber 114. The cover plate is configured to enclose the placement chamber 114, preventing the air nozzle 13 from falling out when not properly positioned therein.

Referring to FIG. 4, which is a perspective view of the hair collection chamber of the pet grooming machine in the present disclosure. The hair collection chamber 12 is detachably coupled to the housing 11. Such a detachable arrangement facilitates easy cleaning of pet hair accumulated inside the hair collection chamber 12.

The hair collection chamber 12 defines a second air inlet 121 and a first air outlet 118. The second air inlet 121 is in communication with the first air inlet 111, allowing airflow from the first air inlet 111 to enter the hair collection chamber 12. The first air outlet 118 is connected to the suction and blowing device 14. The second air inlet 121 cooperates with the first air inlet 111 to guide the airflow that has entered the hair collection chamber 12 into the suction and blowing device 14 for blowing, thereby forming a complete air duct.

A hair-blocking plate 122 formed with a plurality of through-holes 123 is disposed at the first air outlet 118. The hair-blocking plate 122 is configured to prevent pet hair from entering the suction and blowing device 14, while the through-holes 123 allow the airflow in the hair collection chamber 12 to pass therethrough and be discharged.

One end of the housing 11 is further provided with a second air outlet, which is disposed on a side adjacent to the suction and blowing device 14. The second air outlet is configured to allow the airflow from the suction and blowing device 14 to be discharged therethrough.

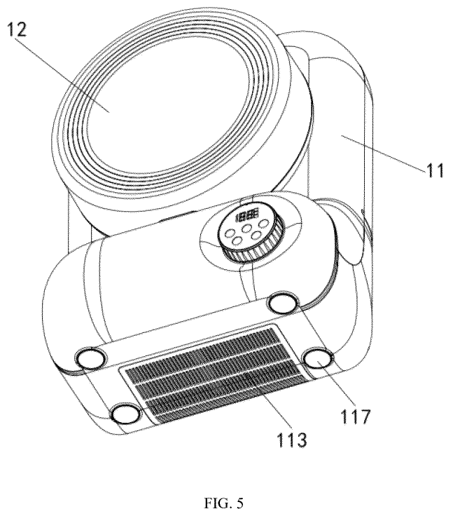

Referring to FIG. 5, which is a perspective view of the pet hair grooming machine according to the present disclosure. The second air outlet is provided with a first grille plate 116 and a second grille plate 113, wherein the first grille plate 116 is disposed on the inner side of the second grille plate 113. The first grille plate 116 and the second grille plate 113 are configured to prevent external debris from entering the housing 11.

The first grille plate 116 is integrally formed with the housing 11, so as to enhance the connection rigidity therebetween and prevent separation of the first grille plate 116 from the housing 11.

The housing 11 is further provided with a handle 112 disposed at an end of the housing 11 away from the second air outlet. The handle 112 is configured to facilitate handling and movement of the pet hair grooming machine.

The housing 11 is further provided with a plurality of cushion blocks 117 disposed around the second air outlet. The cushion blocks 117 are configured to elevate the housing 11 while preventing the second air outlet from being blocked when the pet hair grooming machine is placed.

The following describes the operation principle of the pet hair grooming machine.

The pet hair grooming machine comprises a housing 11, a suction and blowing device 14 disposed within the housing 11, and a hair collection chamber 12 disposed outside the housing 11 and connected to the suction and blowing device 14. The housing 11 is provided with a handle 112 and a second air outlet at its opposite ends, a first air inlet 111 on one side thereof, a placement chamber 114 on the rear side thereof, and a cover plate for closing the placement chamber 114. A clamping member 115 is disposed within the placement chamber 114, and a plurality of positioning slots 1151 are formed in the clamping member 115 for receiving and retaining air nozzles 13 of different shapes. The hair collection chamber 12 is provided with a second air inlet 121 and a first air outlet 118, and a hair-blocking plate 122 formed with a plurality of through-holes 123 is disposed at the first air outlet 118. The second air inlet 121 of the hair collection chamber 12 is in communication with the first air inlet 111 of the housing 11, and the first air outlet 118 of the hair collection chamber 12 is connected to the suction and blowing device 14. The second air outlet is located at a side of the suction and blowing device 14 and is provided with a first grille plate 116 and a second grille plate 113, wherein the first grille plate 116 is integrally formed with the housing 11. The housing 11 is further provided with a plurality of cushion blocks 117 disposed around the second air outlet.

When grooming a pet's hair, first open the cover plate, take out an air nozzle 13 from the clamping member 115, mount the air nozzle 13 at one end of a pipeline, and connect the other end of the pipeline to the first air inlet 111 of the housing 11. Start the suction and blowing device 14, place the air nozzle 13 against the pet, and the pet's hair will enter the pipeline along with the airflow. Since the pipeline is connected to the first air inlet 111 and the second air inlet 121 of the hair collection chamber 12 is in communication with the first air inlet 111, the hair will enter the hair collection chamber 12 through the first air inlet 111 and the second air inlet 121 via the pipeline. Furthermore, under the action of the hair-blocking plate 122, the pet's hair will be collected within the hair collection chamber 12. The airflow entering the hair collection chamber 12 is drawn into the suction and blowing device 14 under the suction action thereof, discharged from the suction and blowing device 14, and then exhausted from the second air outlet of the housing 11. When grooming different parts of the pet, remove the air nozzle 13 from the pipeline, place it in a positioning slot 1151 of the clamping member 115, and take out the corresponding air nozzle 13 to mount it on the pipeline for grooming the pet's hair. After the pet grooming is completed, detach the air nozzle 13 from the pipeline, place it in a positioning slot 1151 of the clamping member 115, and close the cover plate. This effectively prevents the air nozzle 13 from being randomly placed, avoids the pet biting the air nozzle 13 as a toy, and facilitates subsequent use.

In the pet hair grooming machine of this preferred embodiment, during pet hair grooming, by taking out an air nozzle 13 from a positioning slot 1151 and connecting it to the pipeline, and then placing the air nozzle 13 back into the clamping member 115 after the pet hair grooming is completed, on the one hand, random placement of the air nozzle 13 can be effectively avoided, and on the other hand, pets can be prevented from biting the air nozzle 13 as a toy. This prevents damage to the air nozzle 13 and facilitates subsequent use.

In conclusion, although the present disclosure has been disclosed with reference to the above preferred embodiments, they are not intended to limit the present disclosure. Various modifications and alterations may be made by those skilled in the art without departing from the spirit and scope of the present disclosure. Accordingly, the protection scope of the present disclosure shall be defined by the appended claims.

1. A portable pet hair grooming machine, comprising:
a housing;
a pipeline, configured to mounted to the housing;
a suction and blowing device, fixed inside the housing and configured to suction hair;
a hair collection chamber, mounted on an outer surface of the housing and be in communication with the suction and blowing device;
wherein one side of the housing defines a first air inlet in communication with the pipeline and the hair collection chamber; a placement chamber is disposed on the housing and configured to place at least air nozzle, with one air nozzle is selected to couple to the pipeline away from the housing.

2. The portable pet hair grooming machine of claim 1, wherein the placement chamber is disposed on a rear side of the housing, a clamping member disposed within the placement chamber and configured to retain the air nozzles at corresponding positions within the placement chamber; the pet hair grooming further comprises a cover being configured to close or open with relative with the housing so as to cover or uncover the placement chamber.

3. The pet hair grooming machine of claim 1, wherein a plurality of positioning slots are disposed within the clamping member, the clamping member retains the air nozzles by placing the air nozzles in corresponding positioning slots.

4. The pet hair grooming machine of claim 1, wherein the hair collection chamber and the pipeline are detachably connected to the housing.

5. The pet hair grooming machine of claim 1, wherein the hair collection chamber defines a second air inlet, and a first air outlet, the second air inlet in communication with the first air inlet, and the first air outlet is in communication with the suction and blowing device.

6. The pet hair grooming machine of claim 4, wherein a hair blocking plate with a plurality of through holes is disposed within the first air outlet.

7. The pet hair grooming machine of claim 1, wherein a second air outlet is defined at one end of the housing, the second air outlet is disposed on one side adjacent to the suction and blowing device.

8. The pet hair grooming machine of claim 7, wherein a first grille plate and a second grille plate are arranged inside the second air outlet, the first grille plate is disposed on an inner side of the second grille plate.

9. The pet hair grooming machine of claim 8, wherein the first grille plate is integrally formed with the housing.

10. The pet hair grooming machine of claim 9, wherein a handle is disposed on the housing, the handle being located at the end of the housing away from the second air outlet.

11. The pet hair grooming machine of claim 6, wherein a plurality of cushion blocks are arranged on the housing, the cushion blocks are located around the second air outlet.

12. A portable pet hair grooming machine, comprising:
a housing;
a pipeline, detachably mounted to the housing;
a suction and blowing device, disposed within the housing; and
a hair collection chamber, mounted on an outer surface of the housing and in communication with the suction and blowing device;
wherein one side of the housing defines a first air inlet in communication with the pipeline and the hair collection chamber; a placement chamber is disposed on the housing and configured to at least air nozzle, with one air nozzle is selected to coupled to the pipeline away from the housing.

13. The pet hair grooming machine of claim 12, wherein the placement chamber is disposed on a rear side of the housing, a clamping member disposed within the placement chamber and configured to retain air nozzles at corresponding positions within the placement chamber; the pet hair grooming further comprises a cover being configured to close or open with relative with the housing so as to cover or uncover the placement chamber.

14. The pet hair grooming machine of claim 13, wherein the hair collection chamber is detachably mounted on the housing.

15. The pet hair grooming machine of claim 13, wherein the hair collection chamber defines a second air inlet, and a first air outlet, the second air inlet in communication with the first air inlet, and the first air outlet is in communication with the suction and blowing device.

16. The pet hair grooming machine of claim 15, wherein a second air outlet and a handle are disposed on two opposite ends of the housing, the second air outlet is adjacent the suction and blowing device.

17. A portable pet hair grooming machine, comprising:
a housing, one side of the housing defining a first air inlet, and a placement chamber being disposed with the housing to place at least one air nozzles;
a pipeline, mounted to the housing, with one end in communication with the first air inlet, and the other end being coupled to one air nozzle selected;
a suction and blowing device, disposed within the housing; and
a hair collection chamber, mounted on an outer surface of the housing and in communication with the suction and blowing device;
wherein one side of the housing defines a first air inlet in communication with the pipeline and the hair collection chamber; a placement chamber is disposed on the housing and configured to place at least air nozzle, with one air nozzle is selected to couple to the pipeline away from the housing.

18. The portable pet hair grooming machine of claim 17, wherein the placement chamber is disposed on a rear side of the housing, a clamping member disposed within the placement chamber and configured to retain air nozzles at corresponding positions within the placement chamber; the pet hair grooming further comprises a cover being configured to close or open with relative with the housing so as to cover or uncover the placement chamber.

19. The portable pet hair grooming machine of claim 18, wherein the suction and blowing device is disposed bellow the clamping member.

20. The pet hair grooming machine of claim 17, wherein the hair collection chamber is detachably mounted on the housing.
